(19) United States
(12) Patent Application Publication
(10) Pub. No.: US 2003/0128642 A1
(43) Pub. Date: Jul. 10, 2003

(54) Optical disk, optical disk recording and reproducing device, and methodof recording in optical disk

(76) Inventor: Eiji Kawamura, Ehime (JP)

Correspondence Address: ARMSTRONG,WESTERMAN & HATTORI, LLP, 1725 K STREET, NW, SUITE 1000, WASHINGTON, DC, 20006, US

(21) Appl. No.: 10/296,943

(22) PCT Filed: Mar. 29, 2002
(86) PCT No.: PCT/JP02/03157

(30) Foreign Application Priority Data
Apr. 11, 2001 (JP) 2001-113170

(51) Int. Cl. G11B 7/005

(52) U.S. Cl. 369/47.48; 369/275.4

(57) ABSTRACT

An optical disc is formed with a guiding groove from an inner periphery side toward an outer periphery side of the optical disc at constant groove width and constant groove intervals, and the optical disc can detect a predetermined frequency by forming a wobble on an end of the guiding groove. When the wobble is rotated at constant linear velocity, a plurality of constant frequencies are obtained with respect to a predetermined recording position of the guiding groove.

### TECHNICAL FIELD

The present invention relates to a writable optical disc, an optical disc recording and reproducing apparatus, and a recording method on an optical disc.

### BACKGROUND TECHNIQUE

In order to record information in a predetermined location of an optical disc, it is necessary to previously record address information in the disc. As standard means of the recording method of the address information, a helical guiding groove provided in the optical disc is allowed to wobble at a given frequency (22.05H) to provide a wobble. Data such as application code whose frequency is modulated or absolute address is placed on the wobble.

The optical disc recording and reproducing apparatus seeks based on the absolute address placed on the wobble. Special information such as record starting time of media, record ending time and name of producing maker is also embedded in the wobble.

As described above, the absolute address and special information are embedded in the writable optical disc such as present CD-R utilizing the wobble.

However, in order to write more reliably, detailed information concerning optimal recording power such as a difference in sensitivity in an inner periphery and an outer periphery of the media is important. For example, if a lowering degree of recording sensitivity of the outer periphery side with respect to the inner periphery side in unit of a producing maker or rod unit of the optical disc is previously known, it can be utilized as changing control of laser power. Therefore, if information which is more detail as compared with the present state can be embedded, it is possible to write more reliably, but a writable information amount which can be embedded is limited in a structure of the present wobble.

In order to write information into the optical disc more reliably, there is already proposed a method for writing information while detecting the recording sensitivity of a writing location. According to this method, however, there is a problem that processing load on the side of the recording and reproducing apparatus is increased, and it is necessary to enhance the processing ability or to reduce the processing velocity.

On the other hand, in the currently employed standard optical disc such as a CD-R, a CD-RW and a DVD-RAM, a wobble having a constant linear velocity is used. Therefore, the recording and reproducing are carried out by rotating the optical disc at constant linear velocity. According to such a recording and reproducing method using the constant linear velocity, it is necessary to change the rotation speed of the optical disc on the inner periphery side and the outer periphery side. Therefore, when recording is repeatedly carried out between the inner periphery side and the outer periphery side, the number of rotation is largely varied. If the number of rotation of a spindle is varied, power consumption is increased, and latency time for obtaining a predetermined rotation speed which is necessary for recording is required and as a result, there is a problem that the recording time can not be shortened.

There is also proposed a recording method of constant angular velocity (CAV) using a wobble having constant linear velocity which is employed as a standard. That is, when information is recorded on the inner periphery side or the outer periphery side, recording is carried out in a state in which the optical disc is always rotated at constant velocity.

When the disc is rotated at constant angular velocity using a conventional wobble having constant linear velocity, however, if the disc is rotated such as to detect 22.05 kHz on the inner periphery side, detection frequency becomes higher than 22.05 kHz on the outer periphery side. Thereupon, when a wobble having high frequency is detected on the outer periphery side, there is a problem that it is necessary to again execute PDL on the side of the recording and reproducing apparatus and to record information while increasing system clock and thus, a load of the recording and reproducing apparatus is increased.

Further, there is proposed a structure capable of detecting a plurality of frequencies utilizing a wobble. For example, Japanese Patent Application Laid-open No. H6-338066 proposes a structure which changes a wobbling frequency of a guiding groove on opposite sides of a land between the guiding groove. Japanese Patent Application Laid-open No. H11-273089 proposes a structure in which multiplex marks having frequencies shorter than frequency of wobbling are superposed on each other.

These structures are techniques capable of precisely reading out addresses from the groove and land, respectively, so as to record data not only in the groove but also in the land.

Thereupon, it is an object of the present invention to provide an optical disc, an optical disc recording and reproducing apparatus, and a recording method on an optical disc capable of employing, as it is, a structure of a wobble which is employed as a standard at present, and capable of further increasing additional information.

Especially, it is another object of the invention to provide an optical disc, an optical disc recording and reproducing apparatus, and a recording method on an optical disc capable of increasing an amount of information utilized for recording, which corresponds to a recording position of a guiding groove in which information is recorded.

More specifically, it is another object of the invention to provide an optical disc, an optical disc recording and reproducing apparatus, and a recording method on an optical disc capable of previously recording more information which can be utilized for controlling the change of recording power.

It is another object of the invention to provide an optical disc, an optical disc recording and reproducing apparatus, and a recording method on an optical disc capable of previously recording address information for recording at constant angular velocity in addition to address information for recording at constant linear velocity.

### DISCLOSURE OF THE INVENTION

A first aspect of the present invention provides an optical disc which is formed with a guiding groove from an inner periphery side toward an outer periphery side of the optical disc at constant groove width and constant groove intervals, and which can detect a predetermined frequency by forming a wobble on an end of the guiding groove, wherein when the wobble is rotated at constant linear velocity, a plurality of constant frequencies are obtained with respect to a predetermined recording position of the guiding groove.

According to this aspect, it is possible to embed address information for one of constant frequencies in the same manner as that of the conventional technique, and to embed detailed information concerning an optimal recording power value or other recording for each of recording positions for other constant frequency and thus, it is possible to record more reliably.

According to a second aspect of the invention, in the optical disc of the first aspect, also when the wobble is rotated at constant angular velocity, constant frequencies are obtained.

According to this aspect, it is possible to record and reproduce by controlling the rotation at constant linear velocity in the same manner as that of the conventional technique, and to reliably record and reproduce by controlling the rotation at constant angular velocity without applying a load to the recording and reproducing apparatus.

A third aspect of the invention provides an optical disc recording and reproducing apparatus for recording information in an optical disc described in the first or second aspect, an address control signal at the time of recording is read out based on information detected from one of detection frequencies of frequencies obtained from the wobble, and a signal concerning recording power value by recording position is read out based on information detected from the other detection frequency.

According to this aspect, it is possible to embed address information for one of constant frequencies in the same manner as that of the conventional technique, and to embed detailed information concerning an optimal recording power value for each of recording positions for other constant frequency and thus, it is possible to record more reliably.

A fourth aspect of the invention provides a recording method to an optical disc for recording information to the optical disc described in the first or second aspect, wherein a recording position is determined based on information detected from one of detection frequencies of frequencies obtained from the wobble, a recording power value at the time of recording is determined based on information detected from other detection frequency, and information is recorded by recording power which is previously determined by the recording position.

According to this aspect, it is possible to determine the recording position by one of detection frequencies in the same manner as that of the conventional technique, and to determine an optimal recording power value for each of recording positions by other detection frequency and thus, it is possible to record more reliably.

A fifth aspect of the invention provides an optical disc which is formed with a guiding groove from an inner periphery side toward an outer periphery side of the optical disc at constant groove width and constant groove intervals, and which can detect a predetermined frequency by forming a wobble on an end of the guiding groove, wherein a constant frequency can be obtained by rotation of the wobble at constant linear velocity, and a constant frequency can also be obtained by rotation of the wobble at constant angular velocity.

According to this aspect, it is possible to record and reproduce by controlling the rotation at constant linear velocity in the same manner as that of the conventional technique, and to reliably record and reproduce by controlling the rotation at constant angular velocity without applying a load to the recording and reproducing apparatus.

A sixth aspect of the invention provides an optical disc recording and reproducing apparatus for recording information in an optical disc described in the second or fifth aspect, wherein recording or reproducing by rotation at constant linear velocity, and recording or reproducing by rotation at constant angular velocity are carried out.

According to this aspect, it is possible to control the driving operation in accordance with kinds of data to be written or reproduced, e.g., in accordance with data which is continuously or discontinuously written or reproduced, or in accordance with a use of data such as audio data or back-up data. Therefore, it is possible to easily record or reproduce more reliably.

A seventh aspect of the invention provides an optical disc recording and reproducing apparatus which is formed with a guiding groove from an inner periphery side toward an outer periphery side of the optical disc at constant groove width and constant groove intervals, and which can detect a plurality of constant frequencies with respect to a predetermined recording position of the guiding groove by forming a wobble on an edge of the guiding groove, the optical disc recording and reproducing apparatus further comprising: detecting means for detecting a wobble signal from the wobble with respect to a predetermined recording position of the guiding groove, separating means for separating the wobble signals organized according to frequencies, address reading-out means for reading out address information from one of the wobble signals separated by the separating means, sending-control means for determining a sending amount of an optical head based on the address information read out by the address reading-out means, head moving means for operating the optical head based on the sending amount determined by the sending-control means, recorded information reading-out means for reading out record information from the other wobble signal separated by the separating means, recording power control means for determining recording power of the optical head based on information read out by the recorded information reading-out means, and recording power outputting means for outputting recording power determined by the recording power control means.

According to this aspect, it is possible to determine the recording position by one of separated wobble signals in the same manner as that of the conventional technique, and to determine the optimal recording power for each recording position by the other wobble signal. Therefore, it is possible to record more reliably.

An eighth aspect of the invention provides an optical disc recording and reproducing apparatus which is formed with a guiding groove from an inner periphery side toward an outer periphery side of the optical disc at constant groove width and constant groove intervals, and which can detect a plurality of constant frequencies with respect to a predetermined recording position of the guiding groove by forming a wobble on an edge of the guiding groove, the optical disc recording and reproducing apparatus further comprising: detecting means for detecting a wobble signal from the wobble with respect to a predetermined recording position of the guiding groove, separating means for separating the wobble signals organized according to frequencies, driving method switching means for switching a driving operation of the detecting means between constant linear velocity and constant angular velocity, address reading-out means for reading out address information from the wobble signal having corresponding frequency based on a signal from the driving method switching means, sending-control means for determining a sending amount of an optical head based on the address information read out by the address reading-out means, head moving means for operating the optical head based on the sending amount determined by the sending-control means, and driving control means for controlling rotation of said driving means by a corresponding driving method based on a signal from the driving method switching means, wherein said driving means for rotating the optical disc based on a signal from the driving control means.

According to this aspect, address information is read out from a wobble signal of corresponding frequency based on a signal from the driving method switching means. Therefore, it is possible to record and reproduce by controlling the rotation at constant linear velocity in the same manner as that of the conventional technique, and to reliably record and reproduce by controlling the rotation at constant angular velocity without applying a load to the recording and reproducing apparatus.

### BRIEF DESCRIPTION OF THE DRAWINGS

FIG. 1 is a plan view showing a conception of an optical disc according to an embodiment of the present invention.

FIG. 2 is a partial enlarged sectional view of the optical disc of the embodiment.

FIG. 3 is an enlarged view of an essential portion showing a conception of a wobble of the optical disc of the embodiment.

FIG. 4 is an enlarged view of an essential portion showing a conception in which the wobble shown in FIG. 3 is further enlarged.

FIG. 5 is a block diagram showing a structure of an optical disc recording and reproducing apparatus of the embodiment.

FIG. 6 is a block diagram showing a signal generating method for forming a guiding groove according to an embodiment of the present invention.

### BEST MODE FOR CARRYING OUT THE INVENTION

An optical disc, an optical disc recording and reproducing apparatus, and a recording method on an optical disc according to an embodiment of the present invention will be explained below.

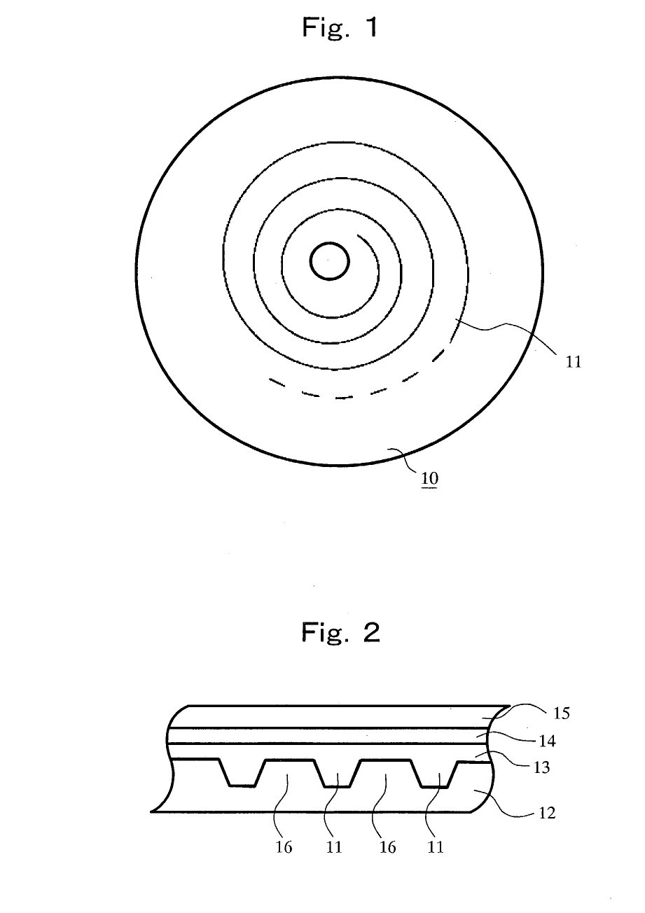

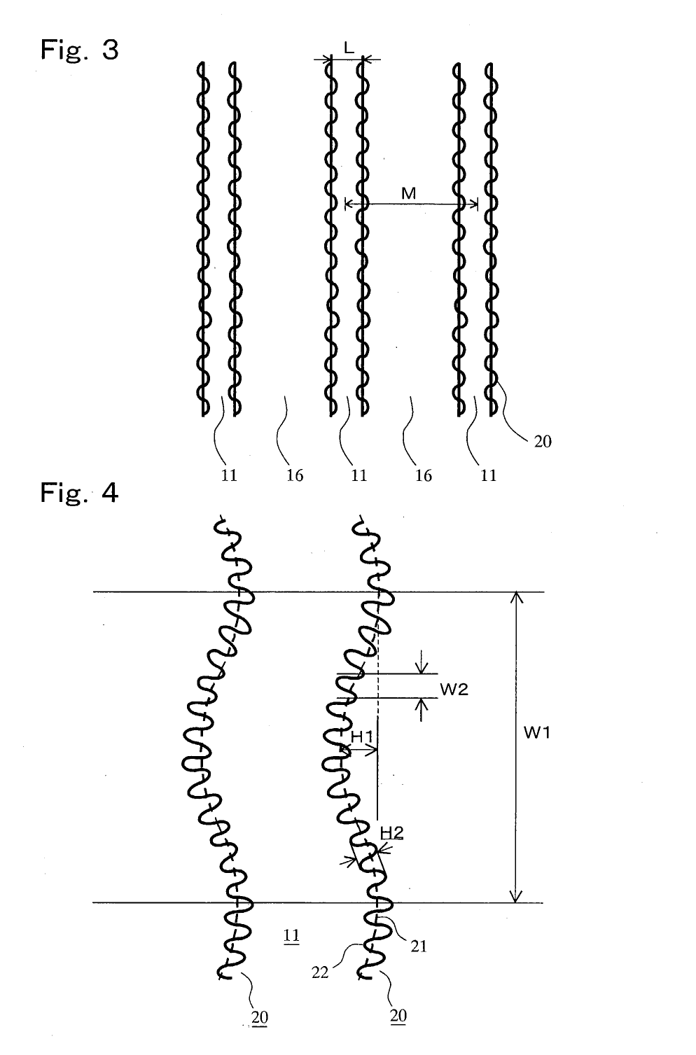

FIG. 1 is a plan view showing a conception of an optical disc according to an embodiment of the present invention. FIG. 2 is a partial enlarged sectional view of the optical disc of the embodiment. FIG. 3 is an enlarged view of an essential portion showing a conception of a wobble of the optical disc of the embodiment. FIG. 4 is an enlarged view of an essential portion showing a conception in which the wobble shown in FIG. 3 is further enlarged.

This embodiment will be explained using an optical disc which is generally recognized as a CD-R.

As shown in FIG. 1, the optical disc of the embodiment employs a sequential writing type recording method in which signals are recorded spirally (helically, or scrolling manner) from an inner periphery side toward an outer periphery side of the disc. There are several types for recording on the disc, and examples of such types are a disc at once type in which data of one disc can not be written or added once, a track at once type in which writing and rewriting in units of track can be done, and a packet write type in which writing and rewriting in units of packet can be done.

FIG. 1 shows an optical disc media 10 according to this embodiment. The optical disc media 10 is spirally formed with a guiding groove 11 which becomes a track in which data is recorded from an inner periphery side to an outer periphery side of the disc.

As shown in FIG. 2, the optical disc media 10 comprises, from its side which is irradiated with laser light, a board 12 made of polycarbonate resin, a recording layer 13 made of cyanine-based or phthalocyanine-based organic coloring agent, a reflecting layer 14 made of gold or silver, and a protecting layer 15 made of UV resin. The board 12 is provided with steps for constituting guiding groove 11 and a land 16 between the guiding groove 11, and the recording layer 13 is superposed on the board 12.

Further, as shown in FIG. 3, each the guiding groove 11 is frequency-modulated and gently sin-waved wobbles (wobble 20). A groove width L of the guiding groove 11 is constant over the entire periphery, and the groove width L is about 0.5 to 0.7 microns. A width M of the land 16 is also constant over the entire periphery, and the width M is about 1.6 microns.

The wobbles 20 will be explained using FIG. 4.

The wobbles 20 are formed on opposite edges of the guiding groove 11. The wobble 20 comprises a first wobble 21 and a second wobble 22.

The first wobble 21 has a period width W1 of 54 to 64 microns and an amplitude H1 of 25 to 36 nanometers such that a center frequency becomes 22.05 kHz.

A time base signal is previously encoded in the first wobble 21 by frequency modulation as a wobble signal. The time base signal is a signal which is generally called as ATIP. The signals are recorded from the beginning of a program area toward the outer periphery of the disc in a simply-increasing manner, and the signals are used for controlling the address at the time of recording when the disc is rotated at constant linear velocity. Here, the time base signal means absolute time (absolute address), and is a standard time code when the disc is rotated at constant linear velocity. Recording power, disc application, starting time of a read-in area, last-possible starting time of a read-out area are encoded in the time base signal in addition to the standard time code. The recording power encoded here is an optimal power which is a value recommended by a maker side, but is an optimal recording power in units of media, and is not an optimal recording power organized according to recording positions.

On the other hand, the second wobble 22 has a period width W2 having a maximum period width smaller than the period width W1 of the first wobble 21, and has an amplitude H2 having a maximum amplitude smaller than the amplitude H1 of the first wobble 21, and the second wobble 22 is superposed on the first wobble 21. A wobble signal by frequency modulation is previously encoded in the second wobble 22 also.

Here, the following embodiments can be realized by a forming method of the second wobble 22 and a signal encoded by frequency modulation.

In one of the embodiments, the second wobble 22 is formed such that a constant frequency can be obtained when the disc is rotated at constant linear velocity, and a signal concerning a recording power value by a recording position of the media is encoded.

Generally, the recording sensitivity of the outer periphery side of the media is lower than that of the inner periphery side thereof. Therefore, information concerning the lowering state of the recording sensitivity, or information concerning a degree of recording power with respect to the recording sensitivity is previously encoded. According to this embodiment, conventional address information and the like can be embedded in the first wobble 21, and detailed information concerning optimal recording power per recording position and information concerning other recording can also be embedded in the second wobble 22. Thus, it is possible to record the information more reliably.

In another embodiment, the second wobble 22 is formed such that a constant frequency can be obtained when the disc is rotated at constant angular velocity, and a time base signal by frequency modulation is previously encoded as a wobble signal.

The signals are also recorded from the beginning of a program area toward the outer periphery of the disc in a simply-increasing manner like the time base signal encoded in the first wobble 21, and the signals are used for controlling the address at the time of recording when the disc is rotated at constant angular velocity. Here, the time base signal means absolute time (absolute address), and is a standard time code when the disc is rotated at constant angular velocity. Recording power, disc application, starting time of a read-in area, last-possible starting time of a read-out area can be encoded in the time base signal in addition to the standard time code. The recording power encoded here is an optimal recording power in units of media which is a value recommended by a maker side, and is not an optimal recording power organized according to recording positions.

According to this embodiment, it is possible to record and reproduce information by controlling the rotation at constant linear velocity based on the time base signal encoded in the first wobble 21 in the same manner as the conventional technique, and it is possible to reliably record and reproduce information by controlling the rotation at constant angular velocity without applying a load to the recording and reproducing apparatus based on the time base signal encoded in the second wobble 22.

In the above embodiment, wobbles 20 each comprising the first wobble 21 and the second wobble 22 are formed on opposite edges of the guiding groove 11, but the wobble 20 may be formed on one of the edges of the guiding groove 11.

Alternatively, the first wobble 21 may be formed on one of the edges, and the second wobble 22 may be formed on the other edge.

Alternatively, a wobble 20 comprising the first wobble 21 and second wobble 22 may be formed on one of the edges, and the first wobble 21 and a third wobble may be formed on the other edge. Here, the third wobble is a wobble which is different from the first wobble and second wobble.

Alternatively, a wobble 20 comprising the first wobble 21 and second wobble 22 may be formed on one of the edges, and the third wobble and a fourth wobble may be formed on the other edge. Here, the third wobble and fourth wobble are wobbles which are different from the first wobble and second wobble.

If the third wobble is provided as described above, it is possible to record and reproduce information by controlling the rotation at constant linear velocity based on the time base signal encoded in the first wobble 21 in the same manner as the conventional technique, it is possible to reliably record and reproduce information by controlling the rotation at constant angular velocity without applying a load to the recording and reproducing apparatus based on the time base signal encoded in the second wobble 22 (or third wobble), it is possible to embed the conventional address information and the like in the first wobble 21, and it is possible to embed detailed information concerning the optimal recording power value of each of recording positions and other recording in the third wobble (or second wobble 22). Therefore, it is possible to record more reliably.

If the third and fourth wobbles are provided as described above, it is possible to record and reproduce information by controlling the rotation at constant linear velocity based on the time base signal encoded in the first wobble 21 in the same manner as the conventional technique, it is possible to reliably record and reproduce information by controlling the rotation at constant angular velocity without applying a load to the recording and reproducing apparatus based on the time base signal encoded in the third wobble, it is possible to embed the conventional address information and the like in the first wobble 21, and it is possible to embed, in the second wobble 22 and the fourth wobble, detailed information concerning the optimal recording power value of each of recording positions and other recording corresponding to a case of the constant linear velocity and a case of the constant angular velocity. Therefore, it is possible to record more reliably.

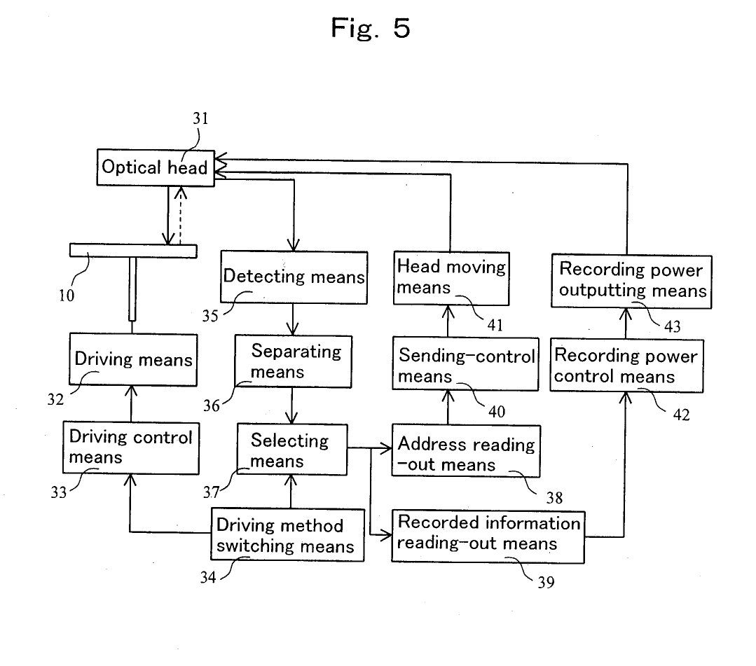

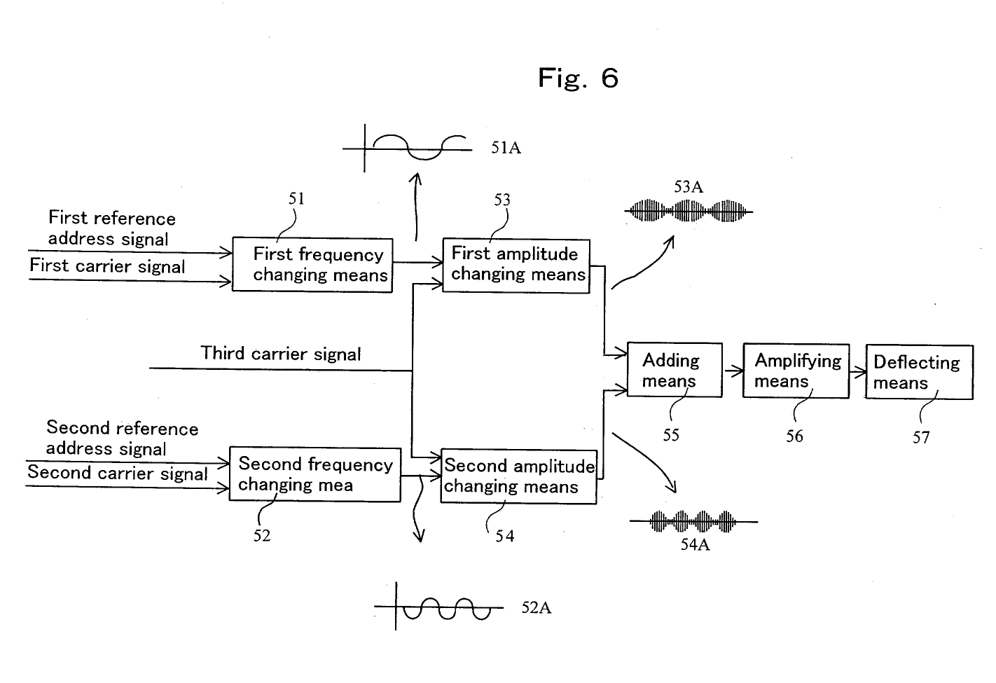

Next, the optical disc recording and reproducing apparatus and the recording method on the optical disc will be explained using FIG. 5. FIG. 5 is a block diagram showing a structure of an optical disc recording and reproducing apparatus of the embodiment.

An optical head 31 constituting the optical disc recording and reproducing apparatus irradiates the optical disc media 10 with laser beam to record data in the guiding groove 11 of the optical disc media 10, and reads out information from reflection light from the optical disc media 10.

On the other hand, driving means 32 constituting the optical disc recording and reproducing apparatus comprises a spindle motor and the like, and rotates the optical disc media 10.

The rotation of the driving means 32 is controlled by driving control means 33. Driving method switching means 34 determines whether the driving control means 33 should control the rotation at constant linear velocity or constant angular velocity, and the driving control means 33 controls the rotation by a control method based on a signal from the driving method switching means 34.

Detecting means 35 detects a wobble signal which is previously encoded in the optical disc media 10 from information by reflection light received by the optical head 31. The wobble signals detected by the detecting means 35 are organized according to frequencies by separating means 36.

Here, if wobble signals for controlling the driving at constant angular velocity are encoded in addition to wobble signals for controlling the driving at constant linear velocity, wobble signals are selected in selecting means 37 based on a signal from the driving method switching means 34.

From wobble signals separated by the separating means 36, address information is read out in address reading-out means 38, and record information is read out in recorded information reading-out means 39. A sending amount of the optical head 31 is determined by sending-control means 40 based on the address information which was read out by the address reading-out means 38. Head moving means 41 actuates the optical head 31 based on the sending amount determined by the sending-control means 40. On the other hand, the recording power of the optical head 31 is determined by the recording power control means 42 based on the information which was read out by the recorded information reading-out means 39. The recording power outputting means 43 outputs laser beam from the optical head 31 based on the recording power determined by the recording power control means 42. According to this embodiment, it is possible to read out an address by the address reading-out means 38 by using one wobble signal separated by the separating means 36, and to determine the recording position in the same manner as that of the conventional technique, and it is possible to read out the record information by the recorded information reading-out means 39 by using the other wobble signal separated by the separating means 36, and to determine the optimal recording power for each of the recording positions and thus, it is possible to record more reliably.

According to this embodiment, address information is read out from a wobble signal having corresponding frequency by the selecting means 37 based on a signal from the driving method switching means 34. Therefore, it is possible to record and reproduce by controlling the rotation at constant linear velocity in the same manner as that of the conventional technique, and it is possible to reliably record and reproduce by controlling the rotation at constant angular velocity without applying a load to the recording and reproducing apparatus.

FIG. 6 is a block diagram showing one embodiment of a signal generating method forming the guiding groove 11 of the optical disc media 10.

A first reference address signal and a first carrier signal forming a first wobble are input to first frequency changing means 51. A second reference address signal and a second carrier signal forming a second wobble are input to second frequency changing means 52. A first frequency modulation signal 51A modulated by first frequency changing means 51 is input to first amplitude changing means 53. A second frequency modulation signal 52A modulated by second frequency changing means 52 is input to second amplitude changing means 54. On the other hand, a third carrier signal is input to the first amplitude changing means 53 and the second amplitude changing means 54.

The first frequency modulation signal 51A is modulated in amplitude by a third carrier signal in the first amplitude changing means 53, and the first amplitude modulation signal 53A which is to be output is input to adding means 55. On the other hand, the second frequency modulation signal 52A is modulated in amplitude by the third carrier signal in the second amplitude changing means 54, and the second amplitude modulation signal 54A which is to be output is also input to the adding means 55. Both the signals are added by the adding means 55 to obtain a wobble signal. The wobble signal is amplified by amplifying means 56 and then, it is supplied to deflecting means 57. In the deflecting means 57, exposure beam is deflected in a direction perpendicular to a track direction of a rotating recording surface of the disc with fine amplitude to form the guiding groove.

Although the CD-R is used as the optical disc in this embodiment, a CD-RW, a DVD-RAM and the like can also be used only if they are writable optical recording media having compatibility with a CD-ROM in terms of reproducing function.

Industrial Applicability

As apparent from the explanation of the above embodiments, according to the present invention, it is possible to embed address information for one of constant frequencies in the same manner as that of the conventional technique, and to embed detailed information concerning an optimal recording power value or other recording for each of recording positions for other constant frequency and thus, it is possible to record more reliably.

Further, according to the invention, it is possible to record and reproduce by controlling the rotation at constant linear velocity in the same manner as that of the conventional technique, and to reliably record and reproduce by controlling the rotation at constant angular velocity without applying a load to the recording and reproducing apparatus.

1. An optical disc which is formed with a guiding groove from an inner periphery side toward an outer periphery side of said optical disc at constant groove width and constant groove intervals, and which can detect a predetermined frequency by forming a wobble on an end of said guiding groove, wherein when said wobble is rotated at constant linear velocity, a plurality of constant frequencies are obtained with respect to a predetermined recording position of said guiding groove.

2. An optical disc according to claim 1, wherein also when said wobble is rotated at constant angular velocity, constant frequencies are obtained.

3. An optical disc recording and reproducing apparatus for recording information in an optical disc described in claim 1 or 2, wherein an address control signal at the time of recording is read out based on information detected from one of detection frequencies of frequencies obtained from said wobble, and a signal concerning recording power value by recording position is read out based on information detected from the other detection frequency.

4. A recording method to an optical disc for recording information to the optical disc described in claim 1 or 2, wherein a recording position is determined based on information detected from one of detection frequencies of frequencies obtained from said wobble, a recording power value at the time of recording is determined based on information detected from other detection frequency, and information is recorded by recording power which is previously determined by the recording position.

5. An optical disc which is formed with a guiding groove from an inner periphery side toward an outer periphery side of said optical disc at constant groove width and constant groove intervals, and which can detect a predetermined frequency by forming a wobble on an end of said guiding groove, wherein a constant frequency can be obtained by rotation of said wobble at constant linear velocity, and a constant frequency can also be obtained by rotation of said wobble at constant angular velocity.

6. An optical disc recording and reproducing apparatus for recording information in an optical disc described in claim 2 or 5, wherein recording or reproducing by rotation at constant linear velocity, and recording or reproducing by rotation at constant angular velocity are carried out.

7. An optical disc recording and reproducing apparatus which is formed with a guiding groove from an inner periphery side toward an outer periphery side of said optical disc at constant groove width and constant groove intervals, and which can detect a plurality of constant frequencies with respect to a predetermined recording position of said guiding groove by forming a wobble on an edge of said guiding groove, said optical disc recording and reproducing apparatus further comprising: detecting means for detecting a wobble signal from said wobble with respect to a predetermined recording position of said guiding groove, separating means for separating said wobble signals organized according to frequencies, address reading-out means for reading out address information from one of the wobble signals separated by said separating means, sending-control means for determining a sending amount of an optical head based on the address information read out by said address reading-out means, head moving means for operating said optical head based on the sending amount determined by said sending-control means, recorded information reading-out means for reading out record information from the other wobble signal separated by said separating means, recording power control means for determining recording power of said optical head based on information read out by said recorded information reading-out means, and recording power outputting means for outputting recording power determined by said recording power control means.

8. An optical disc recording and reproducing apparatus which is formed with a guiding groove from an inner periphery side toward an outer periphery side of said optical disc at constant groove width and constant groove intervals, and which can detect a plurality of constant frequencies with respect to a predetermined recording position of said guiding groove by forming a wobble on an edge of said guiding groove, said optical disc recording and reproducing apparatus further comprising: detecting means for detecting a wobble signal from said wobble with respect to a predetermined recording position of said guiding groove, separating means for separating said wobble signals organized according to frequencies, driving method switching means for switching a driving operation of said detecting means between constant linear velocity and constant angular velocity, address reading-out means for reading out address information from said wobble signal having corresponding frequency based on a signal from said driving method switching means, sending-control means for determining a sending amount of an optical head based on the address information read out by said address reading-out means, head moving means for operating said optical head based on the sending amount determined by said sending-control means, and driving control means for controlling rotation of said driving means by a corresponding driving method based on a signal from said driving method switching means, wherein driving means rotates said optical disc based on a signal from said driving control means.
